(19) United States
(12) Patent Application Publication
(10) Pub. No.: US 2004/0061384 A1
(43) Pub. Date: Apr. 1, 2004

(54) Linear electric machine

(76) Inventors: Shinichi Yatsuzuka, Chiryu-City (JP); Yasumasa Hagiwara, Kariya-City (JP)

Correspondence Address: POSZ & BETHARDS, PLC, 11250 ROGER BACON DRIVE, SUITE 10, RESTON, VA, 20190, US

(21) Appl. No.: 10/625,627

(22) Filed: Jul. 23, 2003

(30) Foreign Application Priority Data
Aug. 26, 2002 (JP) 2002-245180

(51) Int. Cl. H02K 41/00

(52) U.S. Cl. 310/13

(57) ABSTRACT

A linear electric machine includes a plurality of teeth spaced apart from each other, a yoke magnetically connected to the teeth, a plurality of coils mounted on the teeth and a movable core disposed opposite the teeth to reciprocate relative to the teeth along an axis of the movable core. The movable core has a plurality of permanent magnets at axially opposite ends thereof for supplying magnetic flux to the teeth, and a member for suppressing generation of a magnetic field disposed at an axial center of the movable core to magnetically separate the permanent magnets.

### CROSS REFERENCE TO RELATED APPLICATION

The present application is based on and claims priority from Japanese Patent Application 2002-245180, filed Aug. 26, 2002, the contents of which are incorporated herein by reference.

### BACKGROUND OF THE INVENTION

1. Field of the Invention

The present invention relates to a linear electric machine that moves back and forth along a straight line, such as a linear motor, a vibrator or a linear generator.

2. Description of the Related Art

U.S. Pat. No. 6,499,972 B2 discloses an actuator of a linear compressor. The actuator is constituted of a movable core with a plurality of circumferentially disposed permanent magnets on it, a plurality of teeth disposed around the movable core and a plurality of exciting coils respectively mounted on the teeth.

In the linear electric machine, the polarity of the permanent magnets that are disposed opposite ends in the direction of the linear motion has to be made different. The actuator of the linear compressor disclosed in the US patent includes permanents magnets disposed on the opposite ends of the movable core, which are in contact with each other. Therefore, a considerable amount of magnetic flux is confined in the movable core, and magnetic force between the teeth and the movable core can not be sufficiently generated. This lowers the efficiency of the linear electric machine.

That is, a linear actuator or motor having the above structure can not generate sufficient driving force, and a linear generator having the above structure can not generate sufficient electric power.

### SUMMARY OF THE INVENTION

In view of the above described problem, a main object of the invention is to provide an improved linear electric machine that can provide sufficient driving force or electric power.

According to a main feature of the invention, a linear electric machine includes a movable core that has a plurality of first permanent magnets at axially opposite ends for supplying magnetic flux to the teeth and means for suppressing generation of a magnetic field disposed at an axial center thereof to magnetically separate the permanent magnets.

According to another aspect of the invention, a linear electric machine includes a movable core that includes magnetically shielding means for suppressing generation of a magnetic field and a pair of first permanent magnets respectively disposed on the opposite sides of the shielding means in the axial direction.

Therefore, the magnetic flux of the permanent magnet can be effectively utilized.

In the above linear electric machine, the magnetically shielding means may be made of a non-magnetic material. The magnetically shielding means may also be made of a second permanent magnet that has opposite polarity to the first permanent magnets.

The movable core may further include inductors made of magnetic material disposed in magnetic paths between the first permanent magnets and the teeth. 6. In this case, the first permanent magnets are disposed around a center of a plane that is perpendicular to the reciprocating direction of the movable core and polarized in directions perpendicular to the reciprocating direction. The magnetic inductors are disposed between the first permanent magnets in the direction perpendicular to the reciprocating direction. Preferably, a center line (L1) of each first permanent magnet in a radial direction inclines to a center line (L2) of the teeth. In the linear electric machine having the above features, the first permanent magnets may project from the inductors to be located between the adjacent teeth. The movable core may have a magnet shielding member at the center of the cross-section perpendicular to the reciprocating direction of said movable core.

The coils of the linear electric machine may be connected to an ac power source to reciprocate the movable core as a linear motor. On the other hand, the movable core may be connected to means for reciprocating the movable core to generate electric power at the coils.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a schematic diagram illustrating a pulse tube type cooling machine to which a linear electric machine according to the invention is applied;

FIG. 2A is a cross-sectional view of the linear electric machine cut along line II-II in FIG. 1 and FIG. 2B is a cross sectional side view of the linear electric machine cut along line IIB-IIB in FIG. 2A;

FIG. 3 is a schematic diagram illustrating a main feature of the linear electric machine according to the first embodiment of the invention;

FIG. 4A is a perspective view of a movable core of the linear electric machine according to the first embodiment of the invention, and FIG. 4B is a cross sectional view of the movable core;

FIGS. 5A and 5B are schematic perspective views of a spacer of the linear electric machine according to the second embodiment of the invention;

FIG. 6A is a schematic cross-sectional plan view of a linear electric machine according to the third embodiment of the invention, and FIG. 6B is a perspective view thereof;

FIG. 7A is a schematic cross-sectional plan view of a linear electric machine according to the fourth embodiment of the invention, and FIG. 7B is a cross-sectional side view thereof;

FIG. 8 is a schematic cross-sectional plan view of a modification of the linear electric machine according to invention;

FIG. 9 is a schematic cross-sectional plan view of a modification of the linear electric machine according to invention;

FIG. 10 is a schematic cross-sectional plan view of a modification of the linear electric machine according to invention; and

FIG. 11 is a schematic diagram illustrating a generator driven by a thermoacoustic engine.

### DETAILED DESCRIPTION OF THE PREFERRED EMBODIMENTS

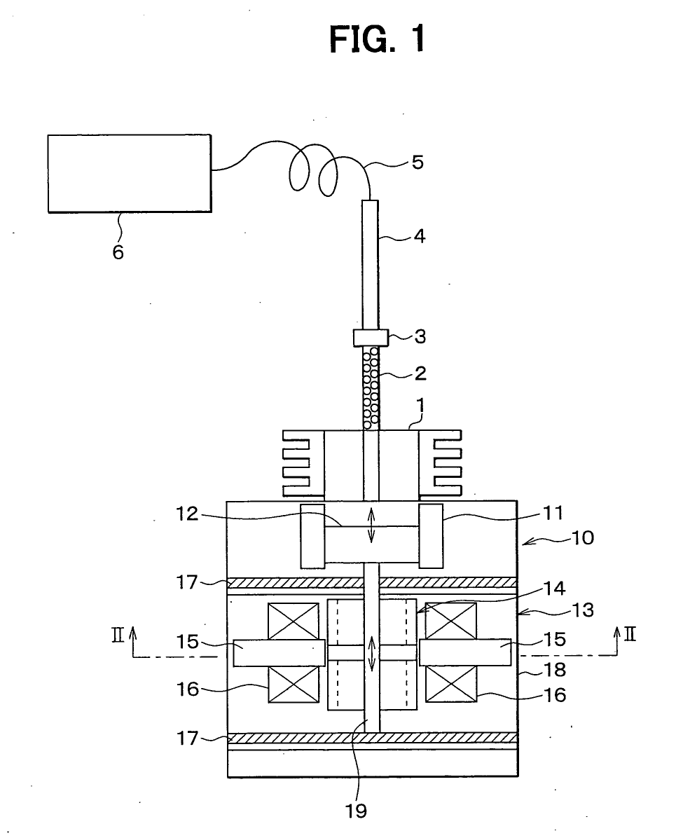

A linear electric machine according to the first embodiment of the invention, which is applied to an actuator of a linear compressor for a pulse tube type cooling machine, will be described with reference to FIGS. 1-4. As disclosed in U.S. Pat. No. 6,499,972 B2, the pulse tube type cooling machine includes a radiator 1, a heat accumulator 2, a heat extractor 3, a pulse tube 4, a capillary tube 5, a buffer tank 6, a linear compressor 10, etc. The linear compressor 10 includes a cylinder 11, a piston 12 disposed in the cylinder 11 and an actuator 13 that reciprocates the piston 12 along the inside surface of the cylinder 11.

The actuator 13 includes a movable core 14 that is disposed to move back and forth on a line of reciprocation, a plurality of magnetic teeth 15 that extends in the radial direction perpendicular to the line of reciprocation, a plurality of solenoid coils 16 respectively mounted on the teeth 15, a leaf spring 17 that supports the movable core 14 and a casing 18 that accommodates the above described parts or components. The casing 18 is a pressure vessel made of stainless steel. The piston 12 and the movable core 14 are connected by a non-magnetic shaft 19 that penetrates the movable core 14 in the axial direction thereof or in the direction of motion of the movable core 14. The solenoid coil 16 is constituted of a resinous non-magnetic bobbin and a conductive coil made of copper or aluminum.

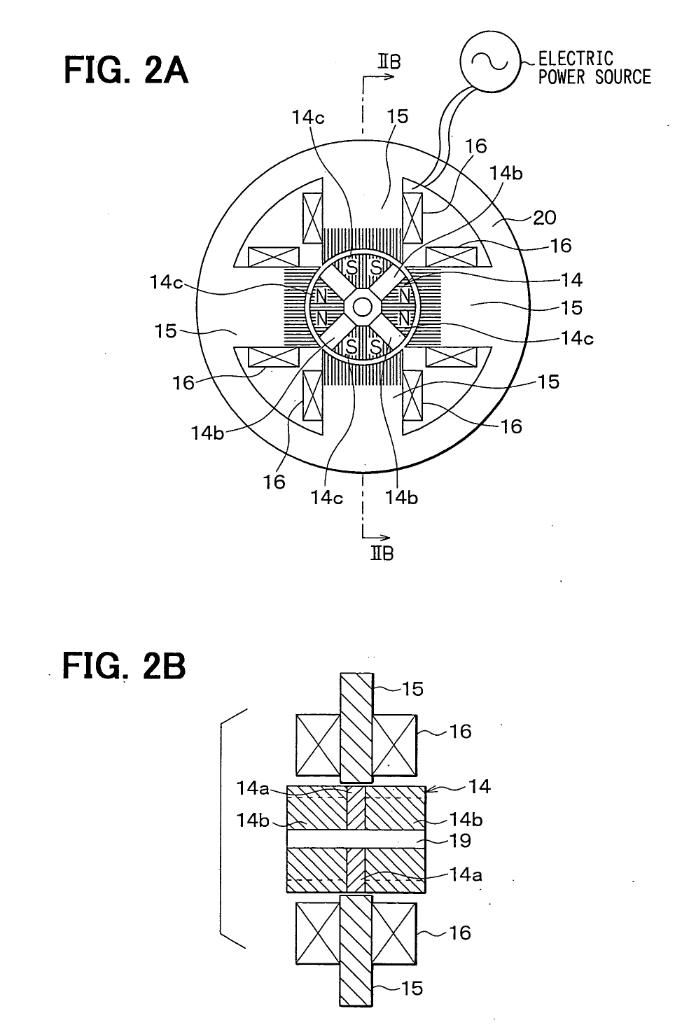

A plurality (e.g. four) of the teeth 15 are disposed around the generally columnar movable core 14 to protrude radially inward from an annular yoke 20, as shown in FIG. 2A. The teeth 15 and the yoke 20 are constituted of laminated magnetic plates such as magnetic iron sheets or permendur sheets to form magnetic paths of the magnetic flux induced by the solenoid coil 16. The laminated magnetic plates are disposed so that the lamination direction thereof can be parallel to the direction of motion of the movable core 14. In other words, the movable core 14 and the teeth 15 are disposed so that the lamination directions thereof can be parallel to each other.

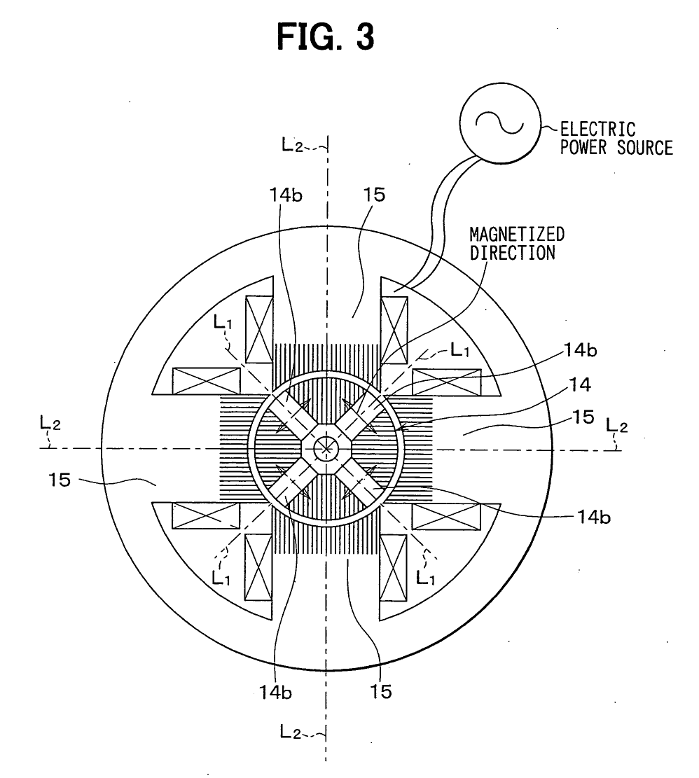

As shown in FIG. 2B, the movable core 14 includes a magnet shielding plate 14a, a plurality (e.g. 8) of permanent magnets 14b and a plurality (e.g. 8) of inductors 14c. The permanent magnets 14b are equally disposed on the opposite sides of the shield plate 14a. The magnet shielding plate 14a is made of non-magnetic material, such as stainless steel, copper and aluminum to prevent the magnetic flux of the permanent magnets from being confined in the movable core 14. In other words, the magnet shielding plate 14a increases effective magnetic flux supplied from the permanent magnets 14b to the teeth 15. The permanent magnets 14b are made from neodymium-iron alloy, samarium-cobalt alloy or ferrite. The permanent magnets 14b are disposed so that the center lines L1 of the permanent magnets 14b in the radial direction can incline to the center lines L2 of the teeth 15, as shown in FIG. 3, and magnetized so that the lines of the magnetic force can be perpendicular to the direction of the motion of the movable core 14. The inclination angle between the center line L1 and the center line L2 is 360 degrees/the number (4) of the teeth/2, or 45 degrees. One of the permanent magnets 14b disposed on one side of the magnet shielding plate 14a is magnetized to have the polarity opposite to the polarity of an adjacent permanent magnet 14b disposed on the other side.

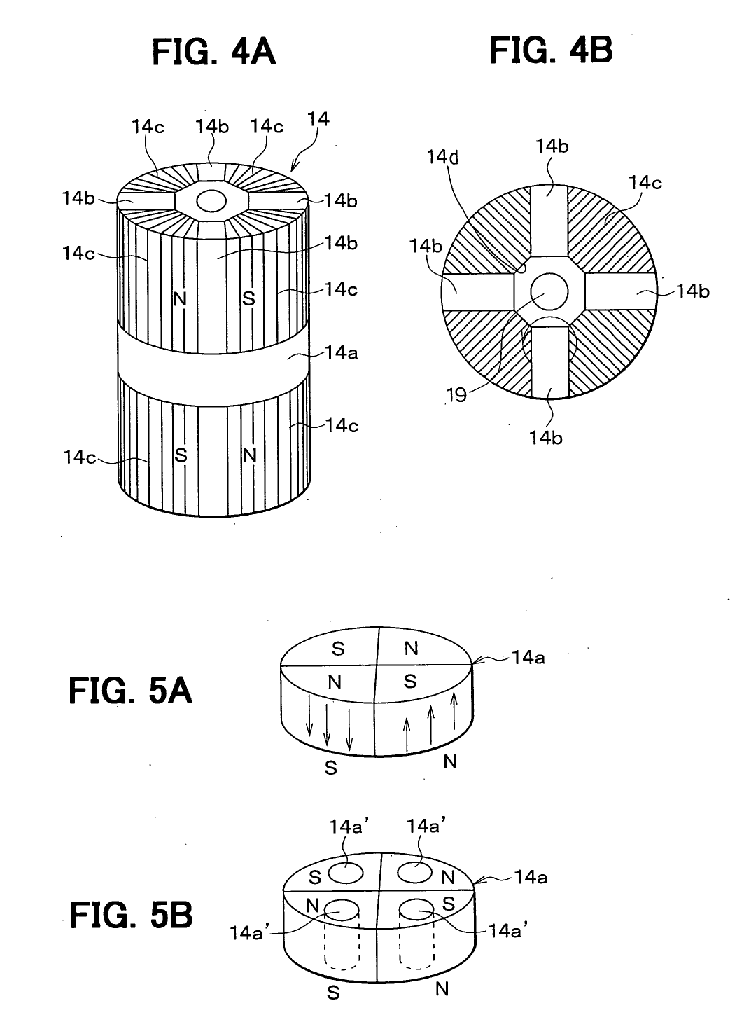

As shown in FIGS. 4A and 4B, each one of the inductors 14c is constituted of radially arranged magnetic plates disposed in a quarter section of the columnar movable core 14 that are respectively divided by the permanent magnets 14b. Each plate lies so that the rolled surface thereof can be approximately in parallel to the direction of motion of the movable core 14. The magnetic plates are made of the same material as the teeth 15, such as magnetic iron sheets or permendur sheets. Therefore, the magnetic flux mainly flows from the permanent magnets 14b through the inductors 14c to the tooth 14.

The movable core 14 has a magnet shielding center hole 14d at the center of the cross-section thereof perpendicular to the direction of motion thereof. The shaft 19 is made of non-magnetic material, such as stainless steel, copper or aluminum, and is force-fitted to the center hole 14d. Each of the magnetic plates disposed around the center hole 14d are arranged to be perpendicular to the direction of motion of the movable core 14. The magnet shielding center hole 14d increases the effective magnetic flux supplied to the teeth 15 from the permanent magnets 14b.

The solenoid coil 16 is applied an output voltage of a electronically control unit, which cyclically changes the magnetic polarity of the teeth 15 at a frequency corresponding to the natural vibration frequency caused by the elasticity of the movable core 14, the leaf spring 17 and working fluid. Accordingly, the attractive and repulsive forces, which are exerted between the teeth 15 and the movable core 14, are cyclically reversed to reciprocate the movable core 14.

The movable core 14 and the teeth 15 are disposed so that the permeance between the movable core 14 and the teeth 15 becomes a maximum when the piston 12 is located at the middle (the center of vibration) between the top dead center and the bottom dead center. In other words, the thrust of the movable core 14 becomes the maximum at the middle or the center of vibration.

A linear electric machine according to the second embodiment of the invention will be described with reference to FIGS. 5A and 5B.

As shown in FIG. 5A, the magnet shielding plate 14a is made of a permanent magnet instead of a non-magnetic material. The permanent magnet shielding plate 14a is magnetized to have the polarities opposite to the polarities of the permanent magnets 14b that is shown in FIG. 4A.

The magnet shielding plate 14a may be constituted of a non-magnetic plate and a plurality of permanent magnet bars 14a′ that are embedded into the non-magnetic plate and magnetized to have the polarities opposite to the polarities of the permanent magnets 14b, as shown in FIG. 5B.

The magnet shielding plate 14a, or 14a′ that is constituted of a permanent magnet or a plurality of permanent magnets increases the effective magnetic flux of the movable core 14, so that the thrust of the movable core 14 can be significantly increased.

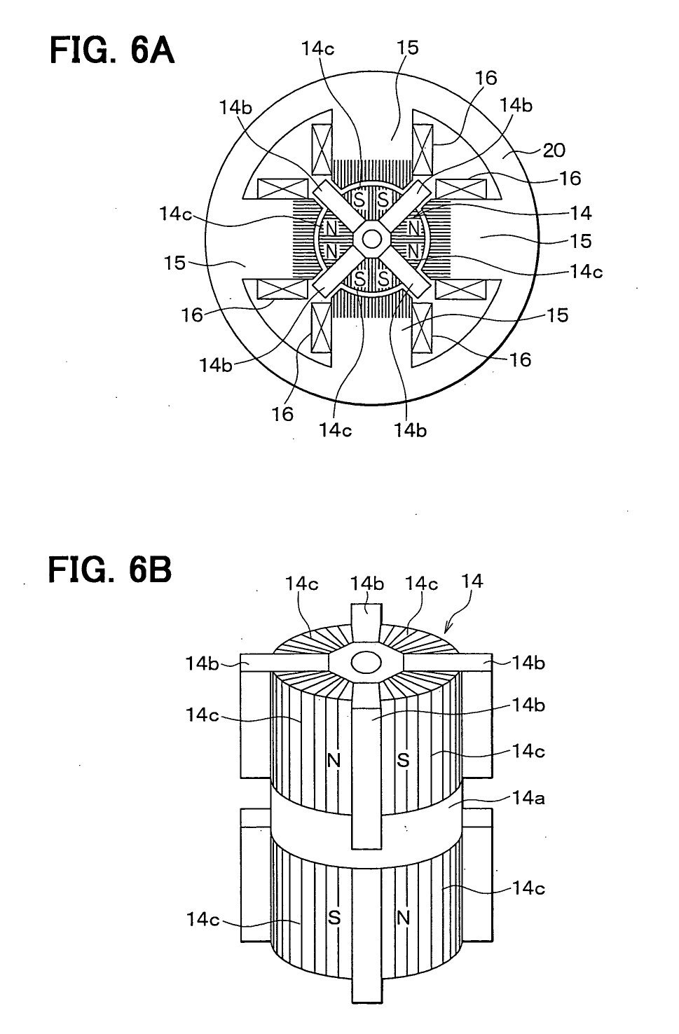

A linear electric machine according to the third embodiment of the invention will be described with reference to FIGS. 6A and 6B. Incidentally, the same reference numeral that indicates a part or component of the following embodiments as the previous embodiment will indicate the same or substantially the same part or component, hereafter.

As shown in FIGS. 6A and 6B, the radially outer portion of each permanent magnets 14b projects from the inductors 14c of the movable core 14 to be located between the adjacent teeth 15.

Therefore, the size of the permanent magnets 14b can be increased so that the effective magnetic flux of the permanent magnets 14b or the thrust of the movable core 14 can be increased without increasing the total volume of the actuator 13.

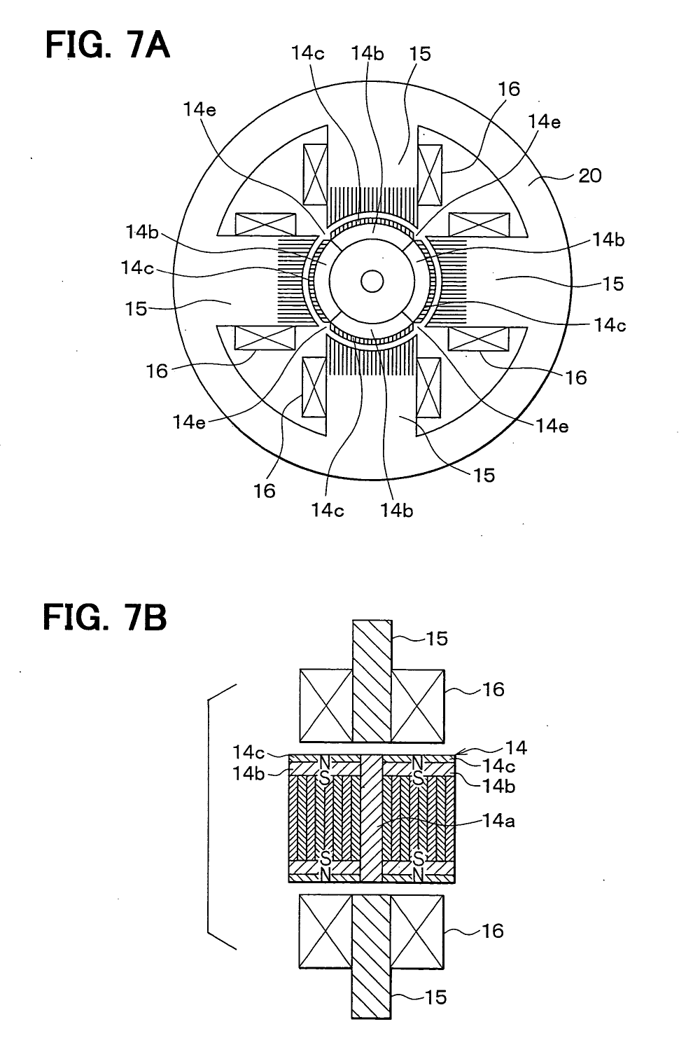

A linear electric machine according to the fourth embodiment of the invention will be described with reference to FIGS. 7A and 7B.

The movable core 14 is constituted of four arc-shaped permanent magnets 14b that are disposed at the peripheral portion of the movable core 14 and four arc-shaped inductors 14c that cover the outer surfaces of the permanent magnets 14b. Numeral 14e indicates a longitudinal magnet shielding groove.

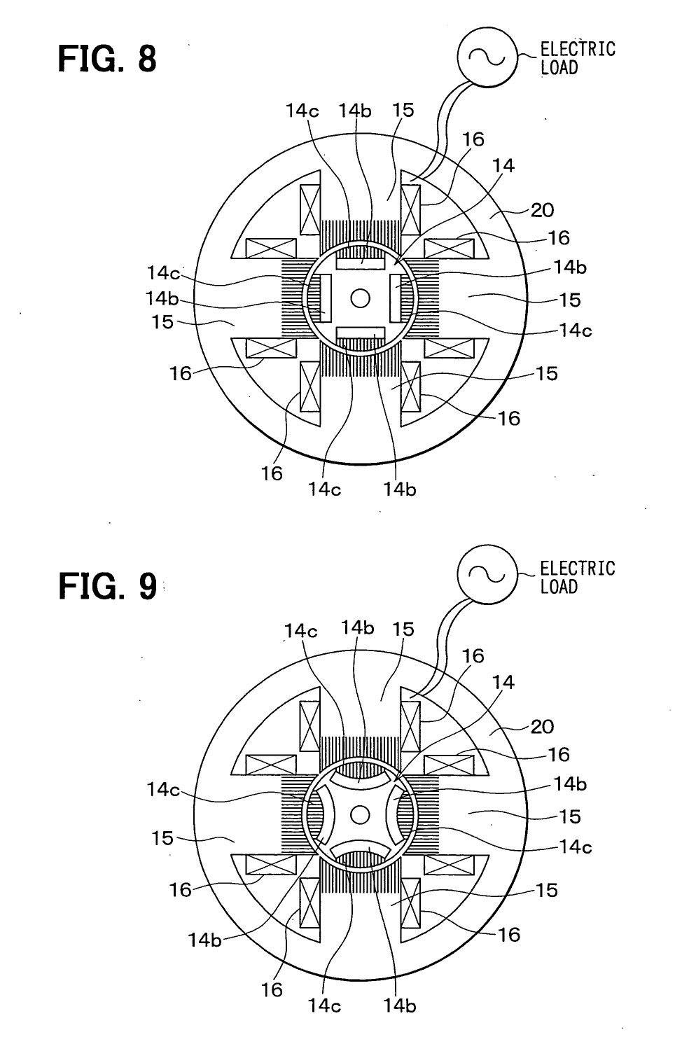

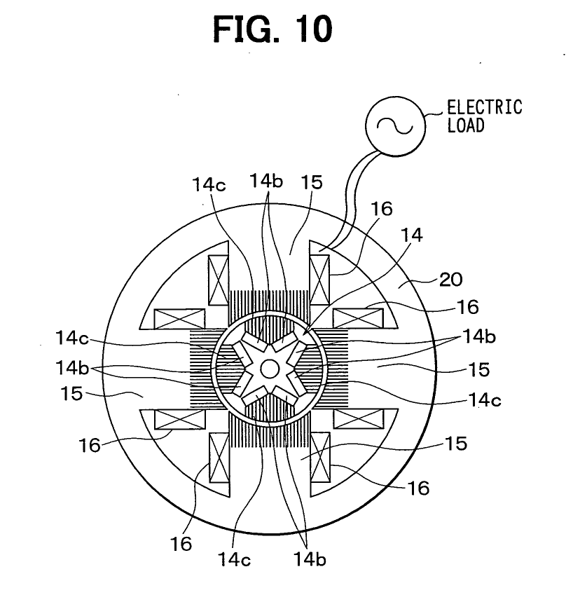

Various modifications of the linear electric machine according to the invention will be described with reference to FIGS. 8-11.

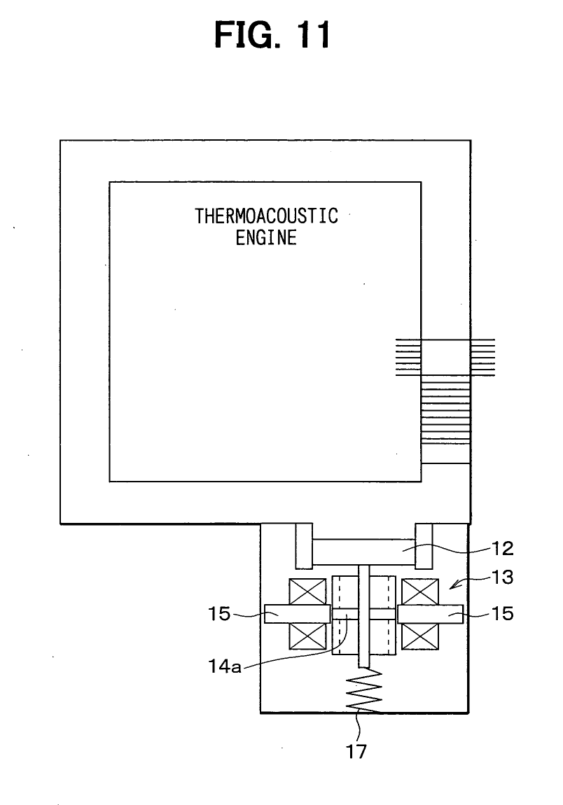

The above described linear electric machines can be utilized as a generator, as shown in FIGS. 8-10. FIG. 11 shows a thermoacoustic engine for reciprocating the movable core 14 of the generators shown in FIGS. 8-10.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A linear electric machine comprising:
a plurality of teeth circumferentially disposed to surround a space;
a yoke disposed around the teeth and magnetically connected to the teeth;
a plurality of coils mounted on the teeth; and
a movable core disposed in the space opposite the teeth to reciprocate transversely to the teeth, said movable core having a plurality of first permanent magnets at axially opposite ends for supplying magnetic flux to the teeth;
wherein said movable core comprises means for suppressing generation of a magnetic field disposed to magnetically separate the permanent magnets.

2. A linear electric machine comprising:
a movable core disposed to be able to reciprocate along an axial direction;
a plurality of magnetic teeth disposed to face the movable core; and
a plurality of coils mounted on the teeth;
wherein said movable core comprises magnetically shielding means for suppressing generation of a magnetic field and a pair of permanent magnets respectively disposed on the opposite sides of the shielding means in the axial direction.

3. The linear electric machine as claimed in claim 2,
wherein said magnetic teeth extend perpendicularly to the axial direction of said movable core.

4. The linear electric machine as claimed in claim 2,
wherein said magnetically shielding means is made of a non-magnetic material.

5. The linear electric machine as claimed in claim 2,
wherein said magnetically shielding means comprises a second permanent magnet that has opposite polarity to the first permanent magnets.

6. The linear electric machine as claimed in claim 2,
wherein said movable core further comprises a inductor made of magnetic material disposed in a magnetic path between the first permanent magnets and the teeth.

7. The linear electric machine as claimed in claim 2, further comprising a plurality of magnetic inductors,
wherein said first permanent magnets are disposed around a center of a plane that is perpendicular to the reciprocating direction of said movable core and polarized in directions perpendicular to the reciprocating direction, and said magnetic inductors are disposed between said first permanent magnets in the direction perpendicular to the reciprocating direction, and
wherein a center line (L1) of each said first permanent magnet in a radial direction inclines to a center line (L2) of the teeth.

8. The linear electric machine as claimed in claim 7,
wherein said first permanent magnets project from said inductors to be located between the adjacent teeth.

9. The linear electric machine as claimed in claim 7,
wherein said movable core has a magnet shielding member at the center of the cross-section perpendicular to the reciprocating direction of said movable core.

10. The linear electric machine as claimed in claim 2,
wherein said coils are connected to an ac power source to reciprocate said movable core.

11. The linear electric machine as claimed in claim 2,
wherein said movable core is connected to means for reciprocating to generate electric power at the coils.
